(19) United States
(12) Patent Application Publication
(10) Pub. No.: US 2010/0269756 A1
(43) Pub. Date: Oct. 28, 2010

(54) SQUIRREL PROOF BIRDFEEDER

(76) Inventor: John F. Trout, Geneva, IL (US)

Correspondence Address: TAYLOR IP, P.C., P.O. Box 560, 142. S Main Street, Avilla, IN, 46710, US

(21) Appl. No.: 12/430,339

(22) Filed: Apr. 27, 2009

(51) Int. Cl. A01K 39/01

(52) U.S. Cl. 119/52.3; 119/52.1; 119/52.2

(57) ABSTRACT

A bird feeder for effectively deterring squirrels and other unwanted animals from accessing the bird feed deposited therein. The bird feeder includes a pair of feeder bins positioned at generally opposite ends of the feeder and a pivot device positioned approximately midway between and removably coupled with the pair of feeder bins.

### BACKGROUND OF THE INVENTION

1. Field of the Invention

The present invention relates to a bird feeder, and, more particularly, to a squirrel proof bird feeder.

2. Description of the Related Art

The study of birds, formally known as ornithology, is a rapidly growing field. Within the field, there are a vast range of enthusiasts from researchers to hobbyists and their numbers are ever increasing. As a result, there is a growing market for methods to attract wild birds to a particular location. The most effective method of attracting birds to a particular site is to provide an attractive environment, which includes suitable nesting sites, minimization of predators, water, and provision for nutritional needs which may be directed to a particular species or a wide range of species. In order to provide for one of the many needs of a variety of birds, numerous bird feeders have been developed for the purpose of attracting birds to a particular site for the enjoyment of bird enthusiasts. This objective has, however, been met with a wide range of challenges. Specifically, a common problem associated with bird feeders is the tendency to attract unwanted animals, for example, squirrels. Squirrels will not only feed at bird feeders, but also raid, or carry food away to their hoard, thereby depleting the available food for desirable birds and potentially destroying the bird feeder in the process. By depleting the available food stock and by their mere presence, squirrels deter desirable wild birds from visiting a site.

There have been a number of attempts to develop an effective squirrel proof bird feeder which are known in the prior art. A complex squirrel deterrent bird feeder system is disclosed in U.S. Pat. No. 6,119,627 (Banyas et al.), specifically, a cylindrical rodent repelling bird feeder including an annular perch and an electric motor geared to the perch. The perch is coupled with the electric motor and the electric motor is reciprocatively mounted in the bird feeder so that when a rodent of excessive weight alights upon the perch the motor is pulled against a resistance spring and a switch is caused to close, thereby engaging the motor which rotates the perch to dislodge the rodent. The complexity of the device and necessity for a supply of electricity make this bird feeder costly to produce and add an additional expense for operation.

U.S. Pat. No. 5,720,238 (Drakos) discloses a spring operated squirrel proof bird feeder including an inner and outer housing with the inner housing fixed vertically with the outer housing telescopically received thereabout and moveable between upper and lower positions. The housings have openings which are aligned and which provide through openings serving as feed ports in the upper position of the outer housing. In the lower position of the outer housing, the openings are misaligned and close the feed ports. The outer housing is also provided with springs biasing the same toward the upper position but allowing the housing to move downwardly to the lower position under the weight of the squirrel. Again, the complexity of the feeder results in high expense in both labor and materials.

U.S. Pat. No. 5,170,750 (Ricketts) discloses a bird feeder including a spring-actuated roof which acts as a catapult when an animal alights thereon. The roof is secured by a latch which disengages when spring loaded pistons urge the roof upward and it can be closed and resecured either manually or automatically by motor. A common problem with existing weight sensitive squirrel deterrent systems is that the weight is set, by the tension of the spring or otherwise, therefore, the system may not be effective in deterring small or immature squirrels from raiding the feeder.

What is needed in the art is a bird feeder which effectively deters squirrels from accessing bird feed deposited therein and destroying the bird feeder.

### SUMMARY OF THE INVENTION

The present invention provides a bird feeder which effectively deters squirrels and other unwanted animals from accessing the bird feed deposited therein. The bird feeder includes a pair of feeder bins positioned at generally opposite ends of the feeder and a pivot device positioned approximately midway between and removably coupled with the pair of feeder bins. The stability of the feeder is easily varied by vertically relocating a horizontal support, which may be a pin, plate, a bolt or a wire. The horizontal support is removeably attached to the feeder in a recess formed between the pair of feeder bins. On each side of the recess and attached to the feeder bins there may be a series of protrusions, slots or holes positioned to correspond with a another set of protrusions, slots or holes located on the opposite feeder bin. The protrusions may extend from the feeder bin itself or may extend from a plate or the like attached to each of the feeder bins. Alternatively, the plurality of corresponding slots or holes may be included in the walls of the recess or in plates or the like attached to each of the feeder bins. Relocation of the horizontal support along one of the pairs of the corresponding protrusions, slots or holes, in association with the pivot device, provides sufficient instability to the feeder to discourage squirrels from raiding the feed contained therein.

In one embodiment of the present invention, the bird feeder may be mounted to a suspension wire having a ball at one end, the ball positioned within a conical recess of the pivot device, thereby movably coupling the suspension wire with the pivot device. The suspension wire extends through a slot in the roof allowing the wire to remain plumb with a hinge point on the pivot device. The stability of the feeder can be adjusted by relocating the horizontal support in a vertical direction.

In a second embodiment of the present invention, the bird feeder may be mounted on a post. In this embodiment, the post may include an elongate protrusion which, when coupled with the bird feeder, extends into the conical recess of a socket included in the pivot device. Thus, when trying to access the food stock by climbing up the post, a squirrel is met by the conical recess of the socket, which provides another barrier for the squirrel to get past.

Alternatively, the vertical support may include a pair of beams extending into the recess between the bins of the bird feeder. The vertical support may be mounted to the feeder by a pin, bolt or wire extending through a pair of holes of a series of corresponding holes included in the pair of beams extending vertically into the recess between the feeder bins. In this case, the horizontal support, in the form of a pin, wire or bolt, is operable coupled with the vertical support such that horizontal support itself provides the hinge point. Relocation of the pin, wire or bolt in a vertical direction adjusts the stability of the bird feeder.

As an option, this embodiment may also include a boost stick having a slit along the length of same, which is removably coupled with the post. The boost stick enables the user to retrieve the bird feeder for refilling from a greater height than the user's natural reach by using the boost stick to push the feeder up and off the post. An advantage of this option is that the boost stick allows the user to place the feeder on a taller post, which is an attractive feature for many bird enthusiasts.

An advantage of the present invention is that the device is an effective way of deterring squirrels from raiding the food stores located within the bird feeder of the present invention. A visit to the feeder of the present invention by a squirrel will be met with instability sufficient to dislodge the squirrel, thereby, thwarting any effort to raid the stores within, resulting in a maximum available food source for desirable wild birds.

Another advantage of the present invention is that the simplicity of the device provides for reduced cost and labor in manufacturing the device and simplicity in use.

A further advantage of the present invention is the ease with which the bird feeder can be cleaned. By simply removing the lid, the feeder bins are easily accessible for cleaning before replenishing the food stock.

Yet another advantage is the provision of the boost stick, which allows the user to place the bird feeder at a greater height, often providing better visibility and a more attractive environment for desirable wild birds.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an embodiment of the bird feeder of the present invention;

FIG. 2 is a top view of the bird feeder shown in FIG. 1;

FIG. 3 is an end view of the bird feeder shown in FIGS. 1 and 2;

FIG. 4 is a schematic illustration of a portion of another embodiment of a bird feeder of the present invention;

FIG. 5 is a side view of a mounting post and boost stick of the present invention which may be used with the bird feeder shown in FIGS. 1-3;

FIG. 6 is a sectional view of the mounting post and boost stick shown in FIG. 5, taken along line 6-6 in FIG. 5; and

FIG. 7 is a side view of another embodiment of the bird feeder of the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

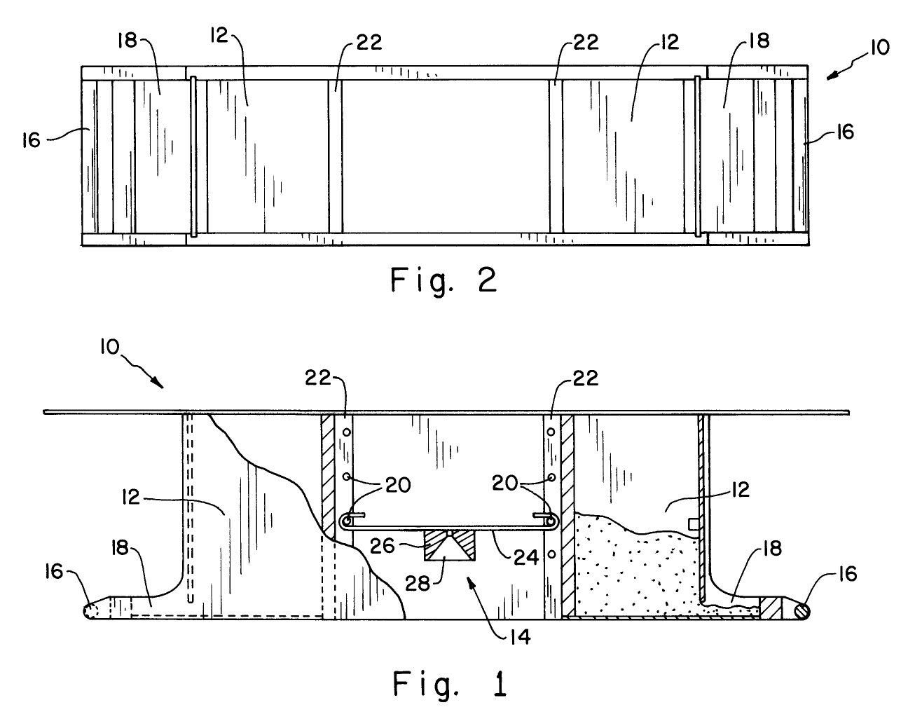

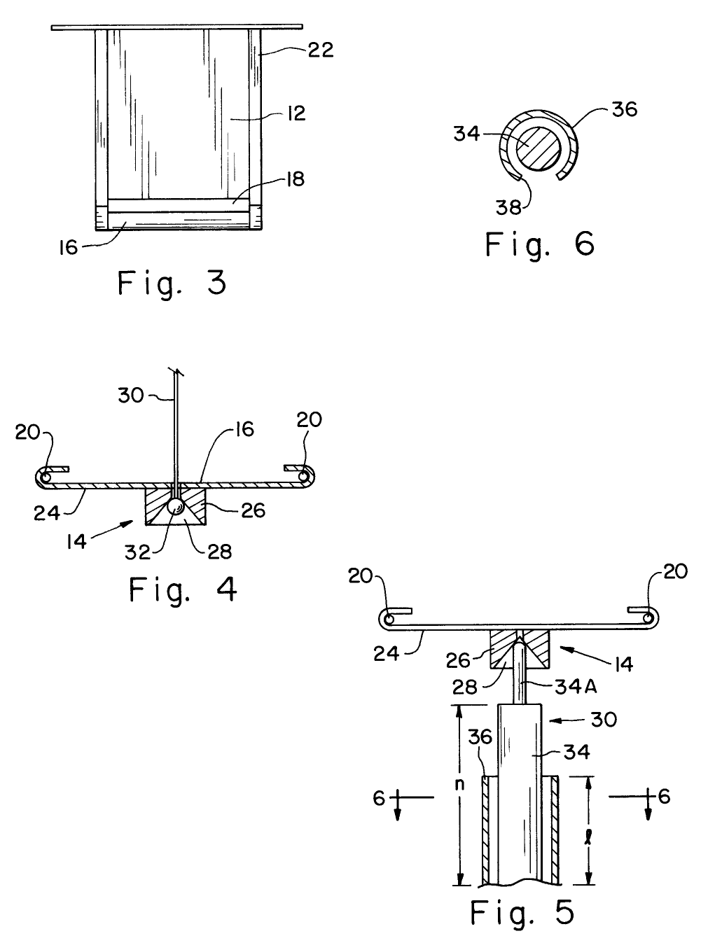

Referring now to the drawings, and more particularly to FIGS. 1-3, there is shown a bird feeder 10 which generally includes a pair of feeder bins 12 and pivot device 14 positioned approximately midway between and removably coupled with the pair of feeder bins 12. Feeder bins 12 are positioned at generally opposite ends of bird feeder 10. Each of feeder bins 12 includes at least one perch 16 and at least one feeding trough 18. Bird feeder 10 further includes a series of corresponding protrusions 20 extending directly from each of feeder bins 12 or, in the alternative, from at least two plates 22, which are connected to each of feeder bins 12. Horizontal support 24 is movably engaged with a plurality of corresponding protrusions, slots or holes 20 and may include a plate, a pin, a wire, or any combination thereof.

Pivot device 14 includes socket 26 having conical recess 28 therein and is connected to horizontal support 24 such that pivot device 14 is positioned approximately midway between and removably coupled with feeder bins 12. Pivot device 14 is adjustably movable in vertical directions relative to each of feeder bins 12 by relocating horizontal support 24 on a different pair of corresponding protrusions 20, thus providing the predetermined instability sufficient to dislodge unwanted animals from the feeder.

Referring now to FIG. 4, bird feeder 10 may optionally include a vertical support member 30 engaged with pivot device 14. In one embodiment of the present invention, vertical support member 30 is a suspension wire. Ball 32 is connected to an end of suspension wire 34 and is positioned within a socket 28 having a conical recess, ball 32 being movably engaged with pivot device 14. Pivot device 14, which is movably engaged with ball 32, is adjustably movable in a vertical direction relative to each of feeder bins 12 by relocating horizontal support 24 on a different pair of corresponding protrusions 20, thereby providing the predetermined instability sufficient to dislodge unwanted animals from the feeder.

Referring now to FIGS. 5 and 6, there is shown another embodiment of the present invention wherein the vertical support member is a post 34. Post 34 includes an elongate protrusion 34A configured to be movably engaged with pivot device 14. Pivot device 14, which is movably engaged with post 34, is adjustably movable in a vertical direction relative to each of feeder bins 12 by relocating horizontal support 24 on a different pair of corresponding protrusions 20, thereby, providing the predetermined instability sufficient to dislodge unwanted animals from the feeder.

The embodiment of the present invention shown in FIGS. 5 and 6 further includes a boost stick configured to fit around and be removably engaged with post 34. Boost stick 36 has a length 1 along which a slit 38 extends and which is less than the length n of post 34. Boost stick 36 is configured to be movably engaged with the bird feeder such that it may be slid up and along post 34 to lift the feeder off post 34, allowing for placement of the feeder at a greater height while still allowing for easy access to the feeder.

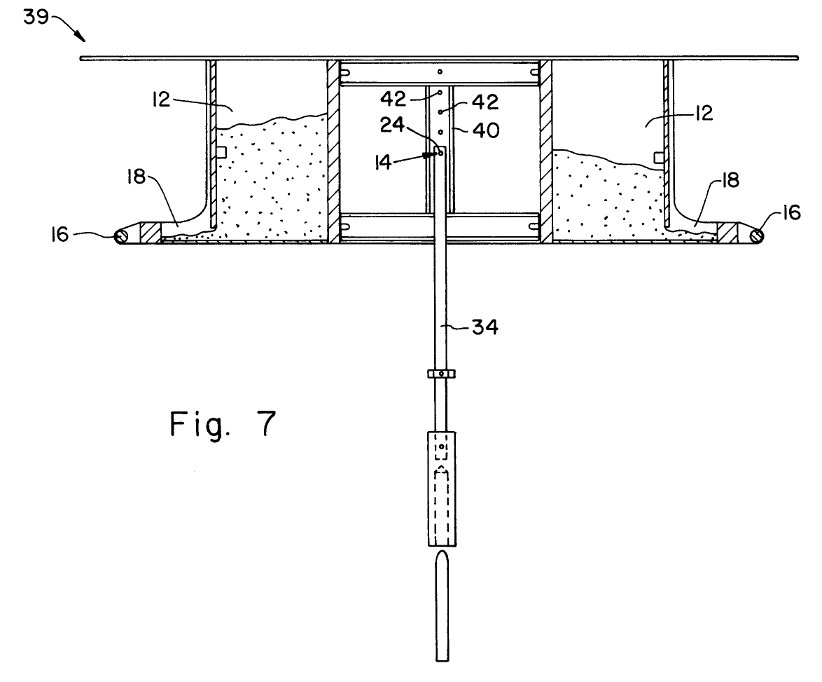

Referring now to FIG. 7, there is shown another embodiment of a bird feeder 39 having post 34 including a pair of beams 40 (one of which is shown). Post 34 may be mounted to bird feeder 39 by horizontal support 24 in the form of a pin, wire or bolt which extends through a pair of holes 42 of a series of corresponding holes included in the pair of beams 40. In this case, post 34 is operably coupled with bird feeder 39 such that horizontal support 24 is pivot device 14. Relocation of horizontal support 24 in a vertical direction adjusts the stability of bird feeder 39 sufficiently to dislodge an unwanted visitor from the feeder.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A bird feeder comprising:
a pair of feeder bins positioned at generally opposite ends of the bird feeder; and
a pivot device positioned approximately midway between and removably coupled with said pair of feeder bins.

2. The bird feeder according to claim 1, wherein said pivot device is adjustably movable in vertical directions relative to each of said feeder bins.

3. The bird feeder according to claim 2, further comprising a horizontal support connected to said pivot device.

4. The bird feeder according to claim 3, wherein said horizontal support is one of a plate, a wire, a bolt and a pin.

5. The bird feeder according to claim 1, further comprising a vertical support member engaged with said pivot device.

6. The bird feeder according to claim 5, wherein said vertical support member is one of a post and a suspension wire.

7. The bird feeder according to claim 1, wherein said pivot device further comprises a socket having a conical recess therein.

8. The bird feeder according to claim 7, wherein said post includes an elongate protrusion configured to be moveably engaged with said pivot device.

9. The bird feeder according to claim 6, wherein said suspension wire includes a ball being coupled with an end of said wire.

10. The bird feeder according to claim 9, wherein said ball is configured to be moveably engaged with said pivoting device.

11. The bird feeder according to claim 1, further comprising a pair of perches being coupled with said feeder bins.

12. The bird feeder according to claim 1, wherein each of said pair of feeder bins includes a feeding trough.

13. The bird feeder according to claim 1, further comprising a pair of plates, each of said pair of plates being coupled with one of said pair of feeder bins.

14. The bird feeder according to claim 13, wherein said pair of plates includes a plurality of corresponding pairs of one of protrusions, slots and holes.

15. The bird feeder according to claim 14, wherein said horizontal support is movably engaged with a pair of said plurality of corresponding pairs of one of protrusions, slots and holes on said plates.

16. The bird feeder according to claim 15, wherein said horizontal support is adjustably connected to said pair of said plurality of corresponding pairs of one of protrusions, slots and holes on said plates.

17. A bird feeder comprising:
a pair of feeder bins positioned at generally opposite ends of said bird feeder;
a pivot device positioned approximately midway between and removably coupled with said pair of feeder bins;
a post, said pivot device being moveably engaged with said post; and
a boost stick, said boost stick being configured to fit around and be removably engaged with said post.

18. The bird feeder according to claim 17, wherein said boost stick has a first length, said boost stick having a slit extending along said first length.

19. The bird feeder according to claim 18, wherein said post has a second length, said first length being less than said second length.

20. The bird feeder according to claim 17, wherein said pivot device further comprises a socket having a conical recess therein, said pivot device being adjustably movable in vertical directions relative to each of said feeder bins.

21. The bird feeder according to claim 20, further comprising a horizontal support connected to said pivot device.

22. The bird feeder according to claim 21, wherein said horizontal support is one of a plate, a wire, a bolt and a pin.

23. The bird feeder according to claim 17, wherein said post includes an elongate protrusion configured to be moveably engaged with said pivot device.

24. The bird feeder according to claim 17, further comprising at least two perches, each of said at least two perches being coupled with one of said feeder bins.

25. The bird feeder according to claim 24, wherein each of said feeder bins includes a feeding trough.

26. The bird feeder according to claim 17, further comprising a pair of plates, each of said plates of said pair of plates being coupled with one of said pair of feeder bins.

27. The bird feeder according to claim 26, wherein said pair of plates includes a plurality of corresponding pairs of one of protrusions, slots and holes.

28. The bird feeder according to claim 27, wherein said horizontal support is movably engaged with a pair of said plurality of corresponding pairs of one of protrusions, slots and holes on said plates.
